(19) United States
(12) Patent Application Publication
(10) Pub. No.: US 2025/0207456 A1
(43) Pub. Date: Jun. 26, 2025

(54) WINDOW OR DOOR HOLLOW CHAMBER PROFILE AND CORNER CONNECTION COMPRISING THE SAME

(71) Applicant: REHAU INDUSTRIES SE & CO. KG, Rehau (DE)

(72) Inventors: Ahmad AL-SHEYYAB, Rehau (DE); Kai BEHREND, Jever (DE); Norbert FINK, Eckental (DE); Christian FRERICHS, Holtgast OT Utgast (DE); Ralf SANDER, Gesees (DE); Stephan SELL, Magdeburg (DE)

(21) Appl. No.: 18/991,210

(22) Filed: Dec. 20, 2024

(30) Foreign Application Priority Data
Dec. 22, 2023 (DE) 102023136435.9
Mar. 18, 2024 (DE) 102024107624.0

(51) Int. Cl. E06B 3/22

(52) U.S. Cl. CPC E06B 3/221

(57) ABSTRACT

The present invention relates to a window or door hollow chamber profile (1), comprising (a) a core profile (30) comprising a plastic matrix formed of thermoplastic material and reinforcing fibres contained in the plastic matrix; and (b) a sheath profile (40) at least partially sheathing the core profile (30) and made of a thermoplastic material compatible with the plastic material of the core profile (30), wherein the window or door hollow chamber profile (1) is distinguished in accordance with the invention in that the thermoplastic material of the core profile (30) is a polyamide material and the reinforcing fibres are short fibres with an average fibre length in the range from 0.1 mm to 12 mm. In addition, the present invention also relates to a corner connection that has been obtained by welding at least partially mitred portions of a window or door hollow chamber profile (1) of this kind.

### FIELD OF THE INVENTION

The invention relates to a window or door hollow chamber profile comprising (a) a core profile comprising a plastic matrix formed of thermoplastic material and reinforcing fibres contained in the plastic matrix; and (b) a sheath profile at least partially sheathing the core profile and made of a thermoplastic material compatible with the plastic material of the core profile. Furthermore, the present invention relates to a corner connection which has been obtained by welding at least partially mitred portions of a window or door hollow chamber profile.

### BACKGROUND OF THE INVENTION

For window and door hollow chamber profiles used to frame glass panes, the aim is to achieve the best possible thermal insulation for the resulting window or door. In order to ensure the mechanical stability required for such windows or doors, it is necessary, for corresponding window or door hollow chamber profiles made of non-reinforced, thermoplastic material, for example polyvinyl chloride (PVC), to insert a usually metal reinforcement profile into at least one of the cavities of the window or door hollow chamber profile, which improves the mechanical stability at the expense of the significantly deteriorated thermal insulation properties. To increase stability with good thermal insulation properties, DE 82 02 221 U1, for example, discloses a profile strip comprising a polyvinyl chloride core profile containing short glass fibres with a length of up to 12 mm in an amount of up to 50% by weight and a PVC sheath profile with high impact strength sheathing the core profile. A disadvantage of the profiled strip described in DE 82 02 221 U1 is that such a profiled strip can only be welded to a corresponding frame with low corner strength, particularly with high fibre content. Furthermore, the moduli of elasticity that can be achieved in this way are not sufficient for a completely steel-free construction of window and door elements in all sizes or for further requirements for window and door hollow chamber profiles with regard to wind load, weight load and thermal load. Therefore, DE 203 02 286 U1 proposes the continuous fibre reinforcement of one or more regions of a window profile made of thermoplastic material with a fibre volume content of more than 20%. Window and door profiles reinforced with continuous fibres have very high moduli of elasticity of up to 70,000 N/mm² in the longitudinal direction of the profile. However, this very high mechanical stability is less pronounced in perpendicular directions. In window and door construction, however, improved stability in the transverse direction would be desirable in order to ensure the secure attachment of fittings such as striking plates, hinges and the like. In addition, window and door profiles reinforced with continuous fibres can only be welded with sufficient corner strength by displacing the reinforced regions from the mitre region.

This is where the present invention comes in, which addresses the problem of providing a window or door hollow chamber profile that at least partially overcomes the disadvantages of the prior art. In particular, the window or door hollow chamber profile according to the invention should have a high mechanical stability both in the longitudinal direction and perpendicular thereto. In addition, the window or door hollow chamber profile according to the invention should be weldable with high corner strength to form a corresponding corner connection without additional effort, such as displacement of the fibre reinforcements. Ultimately, the present invention also lies in the provision of a corner connection which has been obtained by welding at least partially mitre-cut portions of such a window or door hollow chamber profile.

These and other problems are solved according to the invention by a window or door hollow chamber profile having the features described herein or by a corner connection having the features described herein. Preferred embodiments of the window or door hollow chamber profile according to the invention and of the corner connection according to the invention are described herein.

### SUMMARY OF THE INVENTION

According to the present invention, it has surprisingly been recognised that a window or door hollow chamber profile with a fibre-reinforced core profile and a sheath profile with good weldability with high corner strength of the resulting corner connection, which can be achieved without additional effort during welding, is obtained if a polyamide material is used as the thermoplastic material of the core profile and the reinforcing fibres are short fibres with an average fibre length in the range from 0.1 mm to 12 mm, in particular short glass fibres with an average fibre length in the range from 0.1 mm to 12 mm. Such a window or door hollow chamber profile has a high mechanical stability both in the longitudinal direction and perpendicular to it. Furthermore, window or door hollow chamber profiles with a core profile made of a polyamide can still be welded together well with sufficiently high corner strength even with a high proportion of such fibres.

Accordingly, the present invention lies in the provision of a window or door hollow chamber profile comprising (a) a core profile comprising a plastic matrix formed from thermoplastic material and reinforcing fibres contained in the plastic matrix; and (b) a sheath profile at least partially sheathing the core profile and made of a thermoplastic material compatible with the plastic material of the core profile, wherein the window or door hollow chamber profile according to the invention is characterised in that the thermoplastic material of the core profile is a polyamide material and the reinforcing fibres are short fibres with an average fibre length in the range from 0.1 mm to 12 mm. Furthermore, the present invention provides a corner connection which has been obtained by welding together at least partially mitred portions of a window or door hollow chamber profile according to the invention.

As used herein, the term “polyamide material” means a polyamide to which the additives customary for the extrusion of window or door hollow chamber profiles, such as stabilisers, plasticisers, pigments and the like, have been added. Furthermore, the term “weather-side outer wall” as used herein describes that wall of the window or door hollow chamber profile according to the invention which faces the outside of the building when the window or door hollow chamber profile according to the invention is used as intended. Accordingly, the term “room-side outer wall” (the side opposite the weather side) as used herein describes the wall of the window or door hollow chamber profile according to the invention which, when the window or door hollow chamber profile according to the invention is used as intended, faces the room side of the window or door comprising the window or door hollow chamber profile according to the invention. As used herein, “corner strength” means the corner strength according to DIN EN 514:2018-04 (compression bending test) and is determined according to the test specification described therein.

With regard to the window or door hollow chamber profile according to the invention, it may be preferable if the reinforcing fibres are contained in the core profile in a proportion of 10% by weight to 60% by weight, in relation to the weight of the core profile. If the proportion by weight of the reinforcing fibres in the core profile is within the range of 10% by weight to 60% by weight, in relation to the weight of the core profile, excellent moduli of elasticity according to DIN EN ISO 527-4:2022-03 are achieved. The corner connections obtained by welding mitre-cut portions of such window or door hollow chamber profiles according to the invention have sufficient corner strength. In this context, it is preferable if the proportion by weight of the reinforcing fibres in the core profile is within the range from 30% by weight to 50% by weight, particularly preferably within the range from 35% by weight to 48% by weight, in each case in relation to the weight of the core profile.

It can also be advantageous if the average fibre length of the reinforcing fibres is in the range from 0.3 mm to 3.8 mm. An average length of the reinforcing fibres in this range leads to a high mechanical stability of a window or door hollow chamber profile according to the invention, both in the longitudinal direction and perpendicular thereto. In this context, an average fibre length in a range of 1.5 mm to 3.0 mm has proven to be particularly suitable.

The reinforcing fibres are preferably glass fibres or basalt fibres, although other fibres are not excluded according to the invention. Glass fibres give the window or door hollow chamber profile according to the invention a high mechanical stability and are therefore particularly preferred. Basalt fibres improve the thermal insulation properties of the window or door hollow chamber profile according to the invention.

It may also be preferable if the weather-side outer wall and/or the room-side outer wall are at least partially formed by the sheath profile. As a result, the visible surfaces of the structural elements formed from the window or door hollow chamber profile according to the invention, i.e. corresponding windows or doors, are formed from the sheath profile, whereby the core profile, which may be rough on the surface due to the fibres it contains, is covered on the outside by the sheath profile. It is particularly preferable if the weather-side surface of the weather-side outer wall and/or the room-side surface of the room-side outer wall are formed by a preferably 0.3 mm to 1.5 mm thick layer of the sheath profile. The remaining wall thickness of the weather-side outer wall and/or the room-side outer wall can be formed by the core profile. As a result, smooth visible surfaces of the structural elements formed from the window or door hollow chamber profile according to the invention are maintained with very high stability of the formed frame. Preferably, the cover layer formed by the sheath profile has a thickness in the range of about 0.4 mm to about 1.2 mm, in particular from about 0.5 mm to about 0.9 mm, particularly preferably of about 0.6 mm. The sheath profile preferably does not comprise any reinforcing fibres.

It can also be useful if the polyamide of the core profile is selected from the group comprising polyamide-6 (PA 6), polyamide-6.6 (PA 6.6), polyamide-6.10 (PA 6.10), polyamide-4.6 (PA 4.6), polyamide-12 (PA 12) and blends of the aforementioned polyamides. Polyamide-6 is particularly favoured due to its good availability. The thermoplastic material of the sheath profile that is compatible with the plastic material of the core profile is also preferably selected from the group comprising polyamide 6 (PA 6), polyamide 6.6 (PA 6.6), polyamide 6.10 (PA 6.10), polyamide 4.6 (PA 4.6), polyamide 12 (PA 12) and blends of the aforementioned polyamides with each other and with other polymers or copolymers, in particular acrylonitrile-butadiene-styrene terpolymers (ABS) and acrylonitrile-acrylic ester-styrene terpolymers (ASA), wherein blends of the polyamides with an acrylonitrile-acrylic ester-styrene terpolymer (ASA) are preferred due to the good weather resistance thereof. Preferably, the polyamide of the core profile is also used as the thermoplastic material of the sheath profile. In particularly preferred embodiments of the window or door hollow chamber profile according to the invention, polyamide 6 is used as the polyamide of the core profile and a blend of polyamide 6 and an acrylonitrile-acrylic ester-styrene terpolymer is used as the thermoplastic material of the sheath profile.

It can also be advantageous if the window or door hollow chamber profile according to the invention has a modulus of elasticity according to DIN EN ISO 527-2:2012-06 in the range from 4000 N/mm² to 22000 N/mm² in the longitudinal direction of the profile. According to the present invention, excellent moduli of elasticity are achieved in this range. In preferred embodiments, the modulus of elasticity according to DIN EN ISO 527-2:2012-06 is in the range from 7000 N/mm² to 11000 N/mm².

All plastic materials in the window or door hollow chamber profile according to the invention can also be used in the form of materials obtained by a recycling process. In particular, it is preferable that a recycled polyamide is contained in the core profile. In addition or alternatively, “fresh”, i.e. non-recycled, polymer material can also be used in the sheath profile.

The weather-side outer wall and/or the room-side outer wall can preferably be dark-coloured and/or provided with a dark film, paint or coating and/or co-extruded with a dark layer. Although the present method can also be applied to non-coloured white hollow chamber profiles, the problem of profile deformation at high temperatures is more pronounced with dark outer walls. This is counteracted by the high mechanical stability of the window or door hollow chamber profile according to the invention. As used herein, the term “dark” means that more than 50%, preferably more than 60% of the vertically incident sunlight, in each case including the relevant IR range, is absorbed by the dark colouring.

Particularly preferably, the window or door hollow chamber profile according to the invention can be produced in a manner known per se by coextrusion of the core profile and the sheath profile.

Preferably, the window or door hollow chamber profiles according to the invention are used to manufacture a plastic window or a plastic door. A window or door frame can be obtained by welding mitre-cut pieces of a window or door hollow chamber profile according to the invention. The window or door frame is intended for installation in an opening in a wall of a building or can be installed in the opening in the wall of a building.

The explanations with regard to the window or door hollow chamber profile according to the invention apply accordingly with regard to the corner connection according to the invention.

The window or door hollow chamber profile according to the invention and individual parts thereof can also be manufactured line by line or layer by layer using a line-building or layer-building manufacturing process (e.g. 3D printing), but manufacturing by means of coextrusion is preferred.

### BRIEF DESCRIPTION OF THE DRAWINGS

In the following, the present invention will be explained in detail with reference to the embodiments shown in the figures, in which

FIG. 1 shows a cross-sectional view of a window or door hollow chamber profile designed as a window sash profile according to an embodiment of the present invention; and

FIG. 2 shows a cross-sectional view of a window or door hollow chamber profile, also designed as a window sash profile, according to a further embodiment of the present invention.

### DETAILED DESCRIPTION OF EMBODIMENTS OF THE INVENTION

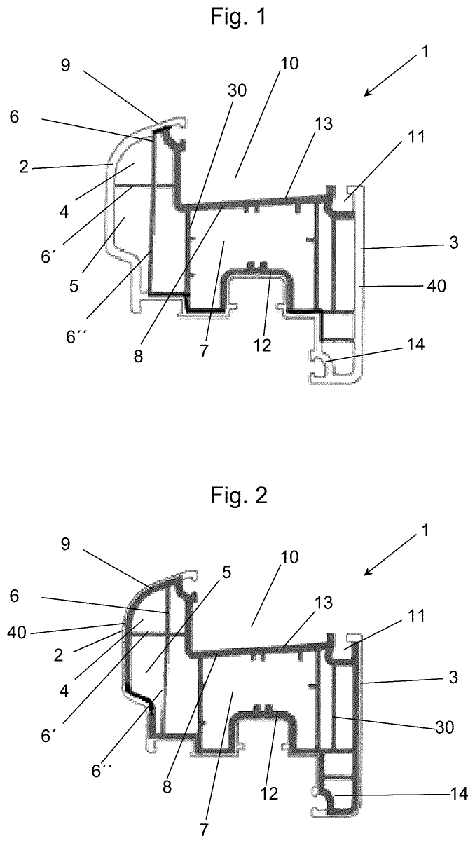

FIG. 1 shows an embodiment of the window or door hollow chamber profile 1 according to the invention using the example of a sash profile for a plastic window in a cross-sectional view. The window or door hollow chamber profile 1 according to the invention comprises a weather-side outer wall 2 and a room-side outer wall 3. Two cavities 4, 5 adjoin the weather-side outer wall 2 and are bounded by walls 6, 6′, 6″ formed as webs and by the weather-side outer wall 2. In the centre, the hollow chamber profile 1 according to the invention comprises a main cavity 7. The upper web 8 of the main cavity 7, together with an outer folded-over portion 5, forms a rebate region 10, in which a panel element, not shown, in particular an insulating glazing unit, can be accommodated. The panel element is stabilised by a glazing bead (not shown), which can be anchored in a glazing bead groove 11 of the cavity profile 1 according to the invention. The outer wall 12 of the hollow chamber profile 1 according to the invention, which is arranged at the bottom in FIG. 1, is referred to as the outer profile wall 12 on the fitting side, while the side opposite the fitting side is referred to as the rebate side with an outer profile wall 13 on the rebate side.

In the embodiment of the window or door hollow chamber profile 1 according to the invention shown in FIG. 1, the central region, which comprises, for example, the walls 6, 6′, 6″, portions of the glazing bead groove 11, a part of the fitting-side profile outer wall 12 and a stop 14 as well as the rebate-side profile outer wall 13, is formed by a core profile 20. The weather-side outer wall 2, the room-side outer wall 3 and the remaining parts of the glazing bead groove 11, the fitting-side outer profile wall 12 and the stop 14 are formed by a sheath profile 40. The core profile 30 is thus partially sheathed by the sheath profile 40. The sheath profile 40 largely forms the outer side of the window or door hollow chamber profile 1 according to the invention, while the core profile is only exposed to the outside in the region of the rebate-side profile outer wall 13 and adjacent thereto.

According to the embodiment of the window or door hollow chamber profile 1 according to the invention shown in FIG. 1, the core profile 30 comprises a plastic matrix of polyamide 6, to which additives customary for the extrusion of window or door hollow chamber profiles, such as stabilisers, plasticisers, pigments and the like, are added. Short glass fibres with an average fibre length of 2.6 mm are embedded in the plastic matrix for reinforcement in a proportion of 48% by weight, in relation to the weight of the core profile 30 as 100% by weight. The cover profile 40 forms a blend of polyamide 6 with acrylonitrile-acrylic ester-styrene terpolymer (ASA). This blend is compatible with the core profile 30. According to the embodiment shown in FIG. 1, acrylonitrile-acrylic ester-styrene terpolymer (ASA) is contained in the blend in a proportion of 38% by weight, in relation to the weight of the sheath profile 40 as 100% by weight.

The window or door hollow chamber profile 1 according to the embodiment of the present invention shown in Fig. has a very good weather resistance and a high mechanical stability both in the longitudinal direction (modulus of elasticity according to DIN EN ISO 527-4:2022-03 of 3400 to 9400 N/mm²) and perpendicular thereto.

The window or door hollow chamber profile 1 according to the invention was produced by coextruding the core profile 30 and the sheath profile 40. Polyamide 6 obtained by a recycling process was used for the core profile 30, while non-recycled polymer material was used for the sheath profile 40.

Despite the high fibre content in the core profile 30, the window or door hollow chamber profile 1 according to the invention can be welded well according to methods known to a person skilled in the art, forming a corner connection according to the invention, without additional measures being taken beyond standard methods for welding plastic profiles. For this purpose, corresponding portions are cut to length from the window or door hollow chamber profile 1 according to the invention, mitred and welded together using a welding table to form a corner connection according to the invention. The resulting corner connection according to the invention has a high corner strength.

FIG. 2 shows a further embodiment of the window or door hollow chamber profile 1 according to the invention. In order to avoid repetition, only differences from the embodiment of the window or door hollow chamber profile 1 according to the invention shown in FIG. 1 are therefore described below. The embodiments of FIG. 1 also apply accordingly to the embodiment shown in FIG. 2. Like elements are identified in the figures by identical reference signs.

In FIG. 2, a further embodiment of the window or door hollow chamber profile 1 according to the invention is also shown using the example of a sash profile for a plastic window in a cross-sectional view. The embodiment shown in FIG. 2 differs from the embodiment described in FIG. 1 with regard to the distribution of the core profile 30 and the sheath profile 40 across the profile cross-section. Thus, in the embodiment shown in FIG. 2, the core profile forms the inner walls and the rebate-side profile outer wall 13 completely, as well as the weather-side outer wall 2 and the room-side outer wall 3 partially facing the inside of the profile. On the visible surfaces, the core profile 30 is surrounded by an approximately 0.7 mm thick cover layer of the sheath profile 40.

According to the embodiment of the window or door hollow chamber profile 1 according to the invention shown in FIG. 2, the core profile 30 in turn comprises a plastic matrix of polyamide 6, to which additives customary for the extrusion of window or door hollow chamber profiles, such as stabilisers, plasticisers, pigments and the like, are added. Short glass fibres with an average fibre length of 2.8 mm are embedded in the plastic matrix for reinforcement in a proportion of 45% by weight, in relation to the weight of the core profile 30 as 100% by weight. The sheath profile 40 is a blend of polyamide 6 with acrylonitrile-acrylic ester-styrene copolymer (ASA), which is compatible with the core profile 30.

The resulting window or door hollow chamber profile 1 according to the embodiment of the present invention shown in Fig. has very good weather resistance and has a high mechanical stability both in the longitudinal direction (modulus of elasticity according to DIN EN ISO 527-2:2012-06 of 10,600 N/mm2) and perpendicular thereto.

The window or door hollow chamber profile 1 according to the invention was produced by coextruding the core profile 30 and the sheath profile 40. Also according to the embodiment shown in FIG. 2, polyamide 6 obtained by a recycling process was used for the core profile 30, while non-recycled polymer material was used for the sheath profile 40.

A corner connection according to the invention can also be formed from the window or door hollow chamber profile 1 shown in FIG. 2 using welding methods known to a person skilled in the art, without the need to take additional measures over and above standard methods for welding plastic profiles. To form the corner connection according to the invention, corresponding portions are cut to length from the window or door hollow chamber profile 1 according to the invention, mitred and welded together using a welding table to form a corner connection according to the invention. The resulting corner connection according to the invention in turn has a high corner strength

The present invention has been described by way of example with reference to hollow chamber profiles for the sash frame of a window. It is understood that the present invention is also applicable to other window or door hollow chamber profiles, in particular frame profiles for a window as well as for frame, architrave or sash frame profiles of a door accordingly.

1. A window or door hollow chamber profile, comprising
(a) a core profile comprising a plastic matrix formed of thermoplastic material and reinforcing fibres contained in the plastic matrix; and
(b) a sheath profile at least partially sheathing the core profile and made of a thermoplastic material compatible with the plastic material of the core profile,
wherein
the thermoplastic material of the core profile is a polyamide material and the reinforcing fibres are short fibres with an average fibre length in the range from 0.1 mm to 12 mm.

2. The window or door hollow chamber profile according to claim 1, wherein the reinforcing fibres are contained in the core profile in a proportion from 10% by weight to 60% by weight, in relation to the weight of the core profile.

3. The window or door hollow chamber profile according to claim 1, wherein the average fibre length of the reinforcing fibres is in the range from 0.3 mm to 3.8 mm, in particular in the range from 1.5 mm to 3.0.

4. The window or door hollow chamber profile according to claims 1, wherein a weather-side outer wall and/or a room-side outer wall are at least partially formed by the sheath profile.

5. The window or door hollow chamber profile according to claim 4, wherein the weather-side surface of the weather-side outer wall and/or the room-side surface of the room-side outer wall are formed by a of the sheath profile.

6. The window or door hollow chamber profile according to claim 5, wherein the thickness of the layer of the sheath profile lies within a range of 0.3 mm to 1.5 mm.

7. The window or door hollow chamber profile according to claims 1, wherein the polyamide of the core profile is selected from the group comprising polyamide-6 (PA 6), polyamide-6.6 (PA 6.6), polyamide-6.10 (PA 6.10), polyamide-4.6 (PA 4.6), polyamide-12 (PA 12) and blends of the aforementioned polyamides.

8. The window or door hollow chamber profile according to claim 1, wherein thermoplastic material of the sheath profile that is compatible with the plastic material of the core profile is selected from the group comprising polyamide 6 (PA 6), polyamide 6.6 (PA 6.6), polyamide 6.10 (PA 6.10), polyamide 4.6 (PA 4.6), polyamide 12 (PA 12) and blends of the aforementioned polyamides with each other and with other polymers or copolymers, in particular acrylonitrile-butadiene-styrene terpolymers (ABS) and acrylonitrile-acrylic ester-styrene terpolymers (ASA).

9. The window or door hollow chamber profile according to claim 1, wherein it has a modulus of elasticity according to DIN EN ISO 527-2:2012-06 in the range from 4000 N/mm² to 22000 N/mm².

10. The window or door hollow chamber profile according to claim 1, wherein the weather-side outer wall and/or the room-side outer wall is/are dark-coloured and/or provided with a dark film, paint or coating and/or co-extruded with a dark layer.

11. A corner connection, obtained by welding at least partially mitred portions of a window or door hollow chamber profile according to claim 1.
